(19) United States
(12) Patent Application Publication
(10) Pub. No.: US 2020/0034804 A1
(43) Pub. Date: Jan. 30, 2020

(54) METHOD FOR DETERMINING AND/OR MONITORING AN AUTOMATION TECHNOLOGY PROCESS VARIABLE

(71) Applicant: Endress+Hauser SE+Co. KG, Maulburg (DE)

(72) Inventors: Dimitri Mousko, Schopfheim (DE); Michael Gunzert, Karlsruhe (DE); Ulrich Kaiser, Basel (CH); Dietmar Spanke, Steinen (DE)

(21) Appl. No.: 16/337,611

(22) PCT Filed: Aug. 28, 2017
(86) PCT No.: PCT/EP2017/071540

§ 371 Date: Mar. 28, 2019

(30) Foreign Application Priority Data
Sep. 30, 2016 (DE) 10 2016 118 611.2

(51) Int. Cl. G06Q 20/06; G05B 19/418

(52) U.S. Cl. CPC G06Q 20/0658; G05B 2219/31368; G05B 19/41885

(57) ABSTRACT

The invention relates to a method for determining or monitoring an automation technology process variable with at least one field device. The method comprises the following method steps: receiving guidelines relating to: access to the data of the field device; the number of times the data of the field device is accessed; or a request for data of the field device. The method also includes steps of storing the data of the field device in an encoded manner in a first service platform that is connected to a second service platform and receiving a request for data at the second service platform, wherein the second service platform accesses the guidelines. The method also includes steps of providing the data according to the guidelines via a first transaction in pre-defined cycles or all at once and generating a request for payment for the data made available according to the guidelines.

The invention relates to a method for determining or monitoring an automation technology process variable with at least one field device.

In automation systems, in particular in process automation systems, field devices serving to capture and/or modify process variables are frequently used. Sensors that are integrated, for example, in fill level measuring devices, flow meters, pressure and temperature measuring devices, pH-redox potential meters, conductivity meters, etc., are used for recording the respective process variables, such as fill level, flow, pressure, temperature, pH level, and conductivity. Actuators, such as, for example, valves or pumps, are used to influence process variables. The flow rate of a fluid in a pipeline section or a filling level in a container can thus be altered by means of actuators. Field devices, in general, refer to all devices which are process-oriented and which supply or process process-relevant information. In the context of the invention, field devices also refer to remote I/Os, radio adapters, and/or, in general, devices that are arranged at the field level. A variety of such field devices are manufactured and marketed by the Endress+Hauser company. The field devices are usually connected to a field bus, and the communication among the field devices and/or with a higher-level unit is carried out via at least one of the field bus protocols that are standard in automation technology. Furthermore, it has become known that field devices are designed to be Internet-capable.

In automation technology, it is standard practice for a customer to purchase at least one field device required for his application. However, U.S. 7,689,511 B2 has also disclosed a method in which the required measured values are provided to a customer; the measuring device itself does convey to the customer's ownership. The measured values of a process variable provided by the field devices are detected with the aid of corresponding sensors and transmitted to a process control system on request. The customer then has access to this data. The number of transmission operations is counted and the cost for the customer is calculated depending on the number of transmission operations. The essential advantage of the invention is that the customer no longer pays for the sensor itself, but only for the data which he actually requires. The object of the invention is to propose a secure method by means of which data of a field device are made available to a customer.

The object is achieved by a method for determining or monitoring at least one process variable in the automation technology, wherein the process variable/variables is/are detected by means of at least one field device having a sensor and/or actuator and an electronic unit. The at least one field device generates data at a predetermined rate that are of interest for at least one customer, wherein the data is in particular measurement data, control data, diagnostic data and/or status data. The at least one field device has a communication interface via which it can be connected directly or indirectly to the Internet.

The following method steps are carried out according to the invention:
the customer concludes a license agreement relating to access to the data of the at least one field device or relating to the number of times the data of the at least one field device made available to the customer per time unit is accessed, or the customer initiates an order of data of the at least one field device—this order can be done once or repeatedly;
the data of the at least one field device are stored in an encoded manner in a first service platform, which is in particular connected to a second service platform;
the customer communicates with the second service platform, which can prepare or reproduce and/or check the license agreement and/or support the execution of the license agreement, or via which the data is ordered;
according to the clauses defined in the license agreement or according to the order, the data is made available to the customer via a first transaction in predefined cycles or all at once;
according to the terms of payment defined in the license agreement, via a second transaction the payment is made for the data made available.

An advantageous further development of the method according to the invention proposes that the first service platform comprises a database in which the data of the field device are stored centrally via a server-client architecture.

An alternative embodiment of the invention method provides that the first service platform is operated in a decentralized manner using a distributed ledger or blockchain technology. The first service platform is made up of a plurality of subscriber nodes, wherein at least one database is integrated in each subscriber node. The data of the field device or field devices are at least partially stored in the databases.

Preferably, the second service platform is operated in a decentralized manner using distributed ledger or blockchain technology. A plurality of subscriber nodes are integrated into the first service platform. In particular, it is provided in this connection that computing units/computers of one or a plurality of customers and/or electronic units of field devices are realized as subscriber nodes.

According to one advantageous embodiment of the method according to the invention, it is proposed that a subscriber node be configured either as a full node version or as a light node version.

Furthermore, in connection with the method according to the invention, it is proposed that ETHEREUM or Blockstream, for example, be used as the second service platform. The blockchain technology or the distributed ledger technology is thus also used for the second service platform. Assets are managed and/or accesses or transfers of assets are regulated via the second service platform. In particular, the second service platform is used to conclude the license agreement, e.g. using smart contracts, and/or to pay for the data provided according to the license agreement. For example, a customer has the possibility of retrieving the data of the field device XYZ once every hour. Preference is given to payment for the data using a cryptocurrency, e.g. Bitcoin. The provision or transmission of the data and the payments are effected via transactions on the second service platform.

The invention is explained in greater detail with reference to the following figures. These show:

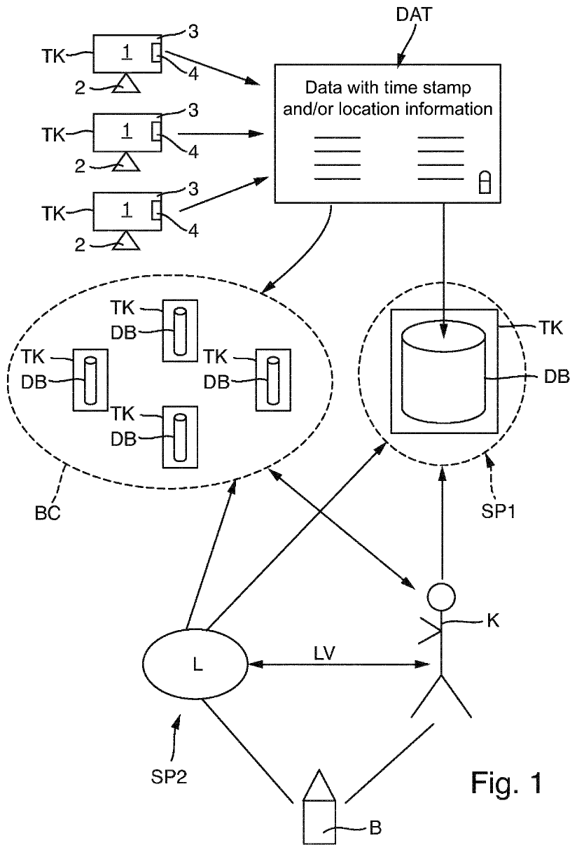

FIG. 1: a schematic representation which illustrates a first embodiment of the method according to the invention,

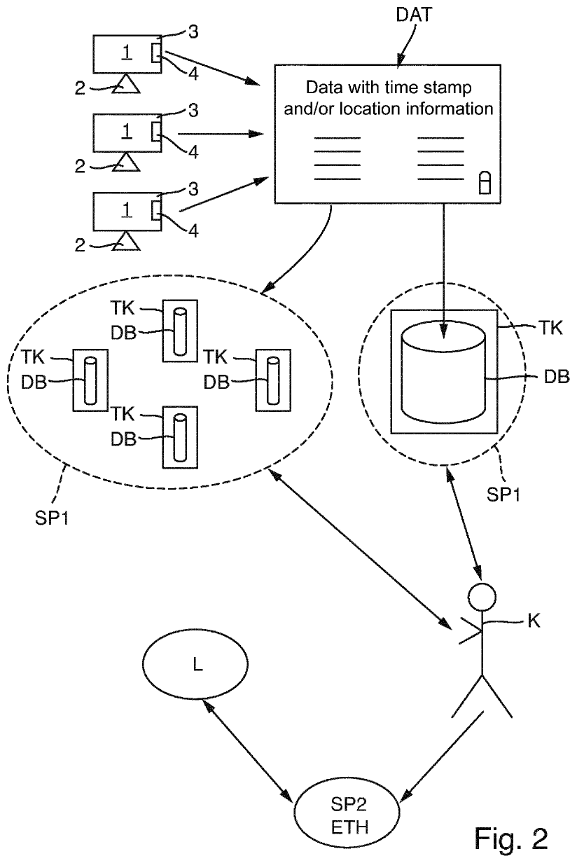

FIG. 2: a schematic representation which illustrates a second embodiment of the method according to the invention, and

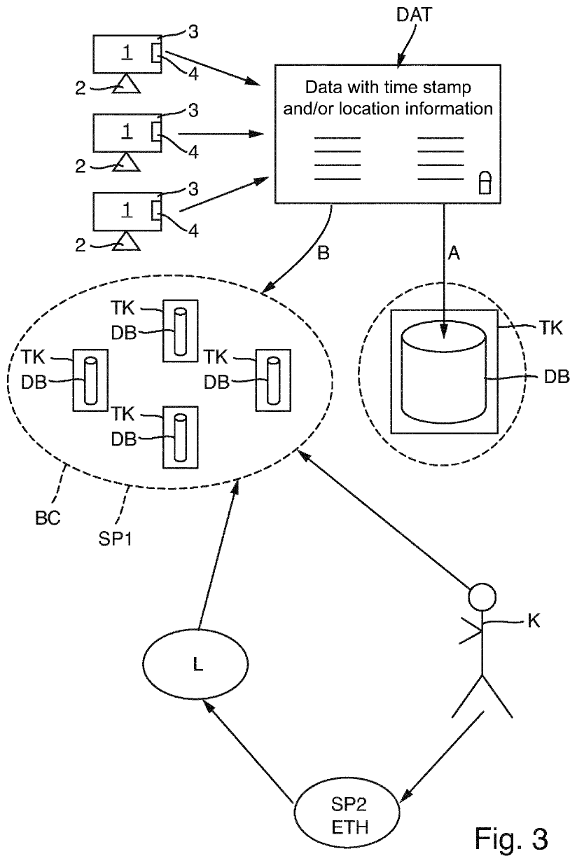

FIG. 3: a schematic representation, which illustrates a third embodiment of the method according to the invention.

FIG. 1 is a schematic representation illustrating a first embodiment of the method according to the invention for determining or monitoring an automation technology process variable. Three field devices 1 are shown by way of example in the left upper region of FIG. 1. That which falls under field device 1 in connection with the invention is already defined in detail in the description introduction. Repetition at this point can therefore be dispensed with.

Each of the field devices 1 comprises at least one sensor 2 and/or actuator and an electronic unit 3. Each field device 1 generates data at a predetermined rate and transmits them via a communication interface to at least one database. Depending on the function of the field device, the field device also receives data and likewise transmits them to a database. These data are of interest to at least one customer. However, depending on the application, the data may also be of interest for a plurality of users. The data are uniquely assigned to a defined field device; furthermore, they are provided with a time stamp and a location indication. Any available GPS location information is already sufficient to characterize and define a field device unambiguously.

Typical data that are of interest for a large segment of customers are, for example, weather data, levels of bodies of water, etc. The data are either fully evaluated data of the field device, or they are so-called raw data, which may converted into evaluated data by a central computing unit in the cloud. For example, raw data of the field devices are transmitted to the customer, wherein the evaluation of the raw data is carried out in the customer's domain. This procedure makes it even more unlikely that unauthorized manipulations of the data can occur.

In many applications, the field devices are installed in the automation technology in a process plant; for example, a chemical or pharmaceutical production process of a product runs in this process plant. The production process is controlled via the field devices, sensors or actuators, but also pumps, so that ultimately the product desired by the customer is produced. The field devices are controlled either from a control room using the field bus protocols customary in automation technology, such as HART, Fieldbus Foundation, Profibus Pa.; however, the control can also be implemented as virtual control in the cloud.

It goes without saying that the data communication can be performed in a wired or wireless manner. In the first case, the communication interfaces 4 are preferably fieldbus interfaces, while in the second case the field device 1 or the field devices 1 must be provided with an Internet-capable communication interface 4. Of course, in connection with the present invention, different hybrid solutions are also possible: for example, the communication takes place at the field level by field bus, while at the control level communication is via an Internet protocol.

Usually, a number of different field devices 1 is required for controlling any process plant. Depending on the application, several hundred field devices can certainly be integrated in a process plant. For monitoring the water level of a river, at least one fill level measuring device may be mounted at each bridge. Of course, there are also processes in which only one field device 1 is used.

The field devices 1 to which the invention refers are in some cases in the possession of the user K, such as in the case when the field devices 1 are installed in a process plant operated by the customer. However, they are usually no longer his property; rather, the field devices 1 in the solution according to the invention are preferably the property of a supplier L. The supplier L is, for example, the manufacturer of the field devices 1 or a service provider. The data DAT provided by the field devices 1 can also be regarded as property of the supplier L, depending on the situation. The ownership relationships are strictly governed in each case in a corresponding and, where applicable, individual license agreement LV between the customer K and the supplier L.

The data DAT are in particular measurement data, control data, diagnostic data and/or status data. However, further processed data, e.g. historical data, and/or other data DAT relevant to the customer K, may also be present. The customer K has the decision as to whether, when and to which data DAT he wants to have access.

The aforementioned designs pertaining to FIG. 1 also apply for the embodiments described hereinafter in FIG. 2 and FIG. 3.

In the method described in FIG. 1, the data DAT of the at least one field device 1 is stored in an encoded manner in a first service platform SP1, which is connected to a second service platform SP2. The first service platform is SP1 operated in a decentralized manner using a distributed ledger or the blockchain BC technology. It is made up of a plurality of subscriber nodes TK, wherein at least one database DB is integrated in each subscriber node TK, and wherein the data DAT of the field device 1 or of the field devices 1 are stored at least in part in the databases DB. The subscriber nodes TK can be computing units of the customer K or of a plurality of customers K; likewise, it is possible to configure the electronic units 3 of field devices 1 as subscriber nodes TK. Each subscriber node TK can be realized as a full node version or as a light node version.

A distributed ledger or a blockchain BC is understood to mean a distributed database having many subscriber nodes, wherein each subscriber node contains an expandable list of data or data records. A blockchain consists of a series of data blocks, in each of which one or more transactions are combined and provided with a checksum. Each transaction contains at least part of a data record. The integrity of the data, thus the protection of the data from subsequent manipulations, is protected by the storage of the cryptographic checksums of the preceding data block in the respectively subsequent data block. New data blocks are created in a computationally intensive process called mining. The data block is then transmitted to all subscriber nodes. Data DAT stored in the blockchain BC cannot subsequently be changed or removed.

A blockchain BC can be described in somewhat more detail as follows: In each telecommunication processing unit configured as a subscriber node, a transaction is created in each case based on the generated data DAT. In addition to the data DAT of the field device 1, each transaction also contains a corresponding time stamp and/or a corresponding location information. Each created transaction is validated at least by a first defined number of interconnected subscriber nodes TK. At predetermined time intervals, at least one validated transaction is processed by at least one subscriber node TK into a data block. This data block is usually transmitted to all subscriber nodes TK integrated in the service platform SP1. Each data block is stored in a decentralized manner in distributed databases DB once the data of the data block of at least a second defined number of subscriber nodes TK of the service platform SP1 are verified. All data blocks contained in the blockchain BC are stored in a subscriber node TK designed as a full node. By contrast, in a subscriber node configured as a light node, only a subset of the data blocks, more precisely the last 100 to 200 data blocks, is stored. By this use of blockchain technology, the necessary data security can be offered to a customer K who usually wants to ensure that no unauthorized party—not even the supplier L—has unauthorized access to the data from his process.

To gain access to the stored data DAT, the customer K concludes a license agreement LV with the supplier L. The license agreement LV governs access to the data DAT and the corresponding payment for access to the data DAT. For example, the customer K is provided with the data per time unit. Of course, it is also possible for the customer to carry out a single or multiple order of data DAT of the field device 1. The license agreement LV is preferably selected or created via the Internet. The customer K contacts the service platform SP2 of the supplier K for this purpose, selects the right variant for his purposes from suitable contractual variants and concludes the license agreement LV while agreeing to the corresponding payment obligation. The service platform SP 2 is thus able to reproduce the license agreement LV and/or to check it. At minimum, it is designed in such a way that the handling of the license agreement LV is supported.

According to the clauses defined in the license agreement or according to the order, the data DAT related to a corresponding transaction are made available to the customer K in predetermined cycles or once; next, or beforehand, the payment for the data DAT made available is made according to the modalities of payment defined in the license agreement LV. In the method shown in FIG. 1, payment is made quite conventionally via a financial institution or a bank B.

FIG. 2 shows a schematic representation that illustrates a second embodiment of the method according to the invention. Only the differences compared to FIG. 1 are shown in the description of FIG. 2. Thus, in the embodiment shown in FIG. 1, blockchain technology is used on the service platform SP1. The blockchain or distributed ledger is used for data storage and for making available the data DAT. By contrast, the preparation of the licensing agreement and the agreed payment are done in a conventional way.

In the embodiment shown in FIG. 2, it is exactly the reverse: the data storage and the provision of data DAT are performed in conventional ways. They nevertheless meet the highest safety requirements. The first service platform SP1 comprises at least one database DB in which the data DAT of the field device 1 or of the field devices 1 are stored and provided in a centralized or decentralized manner via a server-client architecture. Data security is ensured via sufficient encryption and/or individualized data access. In the solution described in FIG. 2, the preparation and/or the conclusion of the license agreement LV as well as the payment for the data DAT made available are effected via a blockchain BC. The second service platform SP2 used is preferably ETHERIUM.

ETHERIUM is a service platform SP2 for programmable smart contracts. The Smart Contracts relate to assets; in the case treated here, the assets are on the one end data DAT and on the other end money. ETHEREUM is based on the already previously described blockchain or distributed ledger technology. ETHERIUM offers the possibility of concluding programmable and intelligent contracts (SMART CONTRACTS) with high security between contracting parties. Smart contracts are computer protocols that reproduce or check the logic of agreements, or technically support their execution. A written specification of the agreement is thus superfluous under certain circumstances. Each subscriber node on the service platform SP2 acts as a quasi register and validator, which can carry out change of ownership and can automatically reproduce verifiable rules related to the transactions. All transactions are always replicated to all other subscriber nodes. Payment for the data DAT made available is likewise effected via ETHERIUM, wherein a cryptocurrency is preferably used. A known cryptocurrency is Bitcoin.

FIG. 3 shows a schematic representation that illustrates a third embodiment of the method according to the invention. In this embodiment, both the first service platform

SP1 and the second service SP2 are configured in distributed ledger or in blockchain technology. Reference is made to the description for gFig. 1 regarding the design of the first service platform as distributed ledger or as blockchain. With respect to the design of the second service platform as distributed ledger or as blockchain, in particular as ETHERIUM, reference is made to the description for FIG. 2.

1-9. (canceled)

10. A method for determining or monitoring an automation technology process variable with at least one field device, wherein the field device has a sensor and/or an actuator and an electronic unit, wherein the field device generates data at a predetermined rate, wherein the data include measurement data, control data, diagnostic data and/or status data, wherein the field device has a communication interface connectable to the Internet, wherein the method includes the following method steps:
receiving guidelines of a license agreement relating to: access to the data of the field device; the number of times the data of the field device is accessed; or a request for data of the field device;
storing the data of the field device in an encoded manner in a first service platform that is connected to a second service platform;
receiving a request for data at the second service platform, wherein the second service platform accesses the guidelines;
providing the data according to the guidelines via a first transaction in predetermined cycles or all at once; and
generating a request for payment for the data made available according to the guidelines.

11. The method of claim 10, wherein the first service platform includes at least one database in which the data of the field device are centrally stored via a server-client architecture.

12. The method of claim 10, wherein the first service platform is operated in a decentralized manner using a distributed ledger or blockchain technology and is made up of a plurality of subscriber nodes, wherein at least one database is integrated in each subscriber node, and wherein the data of the field device or of the field devices are at least partially stored in the databases.

13. The method of claim 12, wherein the second service platform is operated in a decentralized manner using a distributed ledger or blockchain technology and is made up of a plurality of subscriber nodes.

14. The method of claim 12, wherein computing units corresponding to a customer and/or electronic units of field devices are realized as subscriber nodes.

15. The method of claim 12, wherein a subscriber node is configured either as a full node version or as a light node version.

16. The method of claim 10, wherein ETHEREUM or Blockstream is used as the second service platform.

17. The method of claim 10, wherein conclusion of the license agreement and/or payment for the data made available according to the guidelines is made via the second service platform.

18. The method of claim 17, wherein payment is facilitated using cryptocurrency.
